(19) United States
(12) Patent Application Publication
(10) Pub. No.: US 2008/0190252 A1
(43) Pub. Date: Aug. 14, 2008

(54) GLOBAL NAIL SCREW RETAINING SCREWDRIVER

(75) Inventors: Rebecca Parrott, Winona Lake, IN (US); Nicolas Pacelli, Culver, IN (US); Kerry Bodle, South Bend, IN (US)

Correspondence Address: ZIMMER TECHNOLOGY - BAKER & DANIELS, 111 EAST WAYNE STREET, SUITE 800, FORT WAYNE, IN, 46802, US

(73) Assignee: ZIMMER, INC., Warsaw, IN (US)

(21) Appl. No.: 11/740,023

(22) Filed: Apr. 25, 2007

Related U.S. Application Data
(60) Provisional application No. 60/888,840, filed on Feb. 8, 2007.

(51) Int. Cl. B25B 23/10; B25B 23/08

(52) U.S. Cl. 81/451

(57) ABSTRACT

A tool capable of selectively coupling to a fastener.

### BACKGROUND

1. Field of the Invention

The present invention relates to screwdrivers, and, more particularly, to a screwdriver having an apparatus for selectively retaining a screw thereon.

2. Description of the Related Art

It is known to use screw-type devices and associated drivers for bone fracture repair. It can be helpful to selectively couple such screw-type devices to the driver.

Expense associated with surgical procedures is often influenced by the time necessary to perform the surgery, and therefore by the time needed in a surgical operating room. Screw-type devices used for bone fracture repair are ultimately deposited and left within bone. Whereas affixing screws to their drivers provides assurance of the relative position of the screw and driver, an increased degree of screw to driver fixation is often associated with an increased time to effect screw and driver disassociation. Accordingly, increased surety of screw to driver fixation is often achieved at the expense of an expedient later-desired screw and driver disassociation.

### SUMMARY

The present disclosure generally describes a screwdriver and a mating screw that selectively couple and uncouple at the direction of a user.

In one embodiment, the present disclosure provides, in combination, a bone fastener and a fastener drive tool. The drive tool including a handle, a shaft coupled to the handle and including a bit portion on a distal end thereof for engaging a socket of a fastener, and a lock coupled to the shaft for selectively coupling a fastener thereto, the lock having a first lock position to couple the drive tool to the fastener and a second lock position allowing the drive tool to be separated from the fastener. The bone fastener including a socket having at least one shoulder defined therein such that the lock engages the shoulder when the lock is in the first lock position.

Another embodiment of the present disclosure provides a fastener tool. The fastener tool includes a handle, a shaft coupled to the handle and including a bit portion on a distal end thereof for engaging a socket of a fastener, and a lock means for selectively coupling a fastener to the shaft. The lock has a first lock position to couple the drive tool to the fastener and a second lock position allowing the drive tool to be separable from the fastener.

Yet another embodiment of the present disclosure provides a method of attaching a fastener to a patient. The method includes the steps of providing a fastener tool having a lock on a distal end thereof and a switch capable of positioning the lock, placing the lock in a first position, placing the distal end of the tool into a drive socket of the fastener, engaging the lock to couple the fastener to the fastener tool, affixing the fastener within the anatomy of a patient, disengaging the lock to disengage the fastener from the fastener tool, and removing the distal end of the tool from the drive socket of the fastener.

### BRIEF DESCRIPTION OF THE DRAWINGS

The above-mentioned and other features of this invention, and the manner of attaining them, will become more apparent and the invention itself will be better understood by reference to the following description of an embodiment of the invention taken in conjunction with the accompanying drawings, wherein:

FIG. 1 is a perspective view of a driver and associated screw of the present disclosure;

FIGS. 2A&B are partial exploded views of a handle end of the driver of FIG. 1;

FIG. 3A is a perspective view of the driver of FIG. 1 in a disengaged orientation;

FIG. 3B is a partially cross-sectioned view of a head end of the driver and screw of FIG. 3A;

FIG. 3C is a perspective view of the head end of the driver of FIG. 3A;

FIG. 3D is an end view of the screw of FIG. 1 with an internal void shown in phantom;

FIG. 4A is a perspective view of the driver of FIG. 1 in an engaged orientation;

FIG. 4B is a partially cross-sectioned view of a head end of the driver and screw of FIG. 4A;

FIG. 4C is a perspective view of the head end of the driver of FIG. 4A;

FIG. 4D is an overhead view of the screw of FIG. 1 with an internal void shown in phantom and the head end of the driver of FIG. 4A.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

The description that follows refers to a retrograde femoral nail application. While described with respect to a retrograde femoral nail application, the principles of the present invention can be applied to other surgical and non-surgical applications.

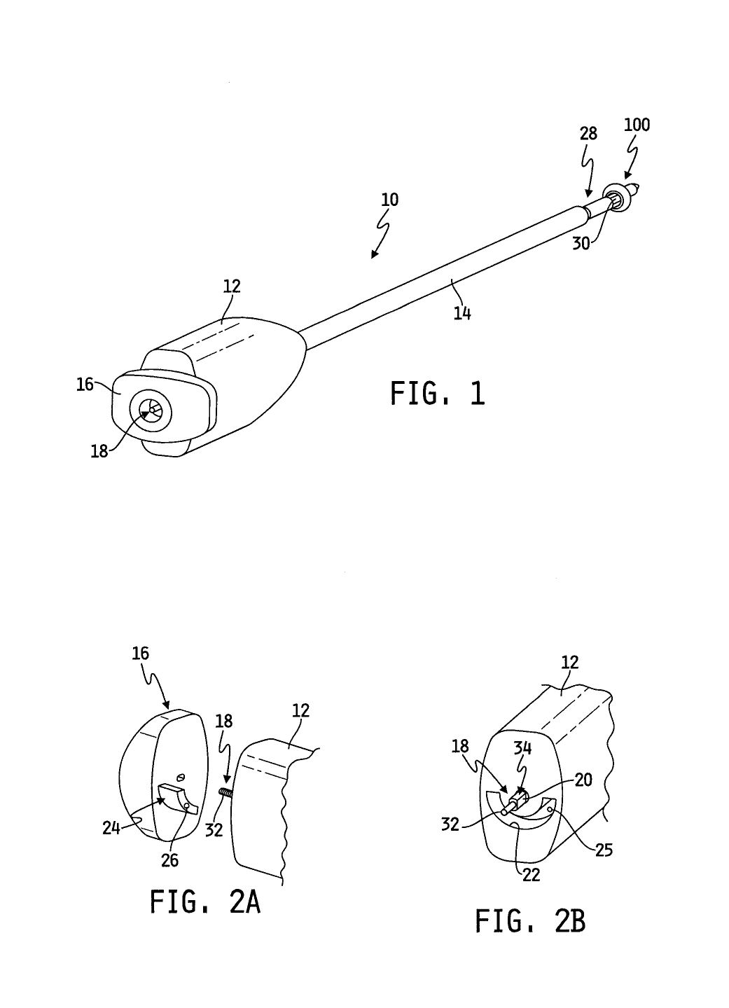

FIG. 1 shows screwdriver 10 and associated bone screw 100. Screwdriver 10 includes handle 12, shaft 14, positive lock 16, locking member 18, and a tension/disassembly knob (not shown). FIG. 2B shows handle 12 with positive lock 16 removed therefrom. Handle 12 includes passageway 20 therein that aligns with a similarly diameter passageway (not shown) within shaft 14. Handle 12 further includes a proximal end having partially-annular slot 22 defined therein.

Screwdriver 10 is configured to securely and selectively couple to bone screw 100. By operating positive lock 16, a user may couple and uncouple screw 100 from a distal end of screwdriver 100. Accordingly, a compact design to prevent unintended disassociation is provided.

Slot 22 of handle 12 is sized to receive a tab or lug 24 defined on positive lock 16 therein. Slot 22 includes two recesses 25 (only one shown) at the bottom thereof sized to receive a detent 26 defined on tab 24 of positive lock 16. The arc length of slot 22 defines the permitted rotational travel of tab 24 and therefore the permitted travel of positive lock 16 relative to handle 12. The length of slot 22 and locations of recesses 25 combine to define the pre-set rotational positions of locking member 18 permitted by screwdriver 10. Positive lock 16 acts as a switch between the pre-set rotational positions. Screwdrivers 10 having a hex driving pattern utilize pre-set rotational positions offset by about 30 degrees from each other. Screwdrivers 10 having a square driving pattern (not shown) utilize pre-set rotational positions offset by about 45 degrees from each other. Screwdrivers 10 having a triangular driving pattern (not shown) utilize pre-set rotational positions offset by about 60 degrees from each other. More generally, for any given driving pattern, pre-set rotational positions are defined by the relationship of: rotational offset angle=180/(number of sides of the selected driving pattern).

When moving from one recess 25 to the other, detent 26 provides tactile feedback and an audible click once detent 26 is seated within a recess 25. Other embodiments provide a recess in positive lock 16 also. In such embodiments, a ball (not shown) is located within recess 25 of positive lock 16. The click can be facilitated by the use of a silicon O-ring (not shown) that compresses until the final position is achieved and the ball seats in a recess of slot 22 of handle 12.

The exterior of handle 12 is sized and shaped to easily and comfortably fit within the hand of a user. A distal end of handle 12 is coupled to shaft 14. It should be appreciated that when the pieces are discussed, “distal” and “proximal” are used relative to the user of screwdriver 10 such that the distal end of screwdriver 10 is farther from the user than the proximal end of screwdriver 10. One embodiment provides a recess (not shown) at the distal end of handle 12 that has an interior cross-section shaped to receive shaft 14 so as to prevent rotation therebetween. Exemplary shapes of the cross section of the recess include hexagonal, square, triangular, and chorded off circles. Shaft 14 may be permanently fixed within the recess, may provide a friction fit within the recess, and may be readily removable via use of the tension/disassembly knob and discussed below.

Shaft 14 includes a proximal end sized and shaped to be received within the distal end of handle 12 as previously discussed. Shaft 14 further includes a distal end 28 that provides a bit portion having driving surfaces 30. Distal end 28 is hexagonal in the provided embodiment. Square, triangle, and other non-circular drivers are also specifically envisioned. Shaft 14 also includes a passageway (not shown) sized to receive screw locking member 18 partially therein.

Screw locking member 18 includes, from proximal to distal, an assembly attachment 32, a chorded positive lock engagement portion 34, a cylindrical portion or rod (not shown), and a lock portion 38. Assembly attachment 32 passes through positive lock 16 and provides for attachment of screw locking member 18 to the tension/disassembly knob. Such attachment may be via a threaded engagement, a void and cotter pin, or any other suitable connection. Chorded positive lock engagement portion 34 is received in a mating bore in positive lock 16. The engagement between lock engagement portion 34 and positive lock 16 prevents relative rotation therebetween such that rotation imparted to positive lock 16 is translated to locking member 18. The cylindrical portion (not shown) of screw locking member 18 has a substantially fixed diameter and extends through handle 12 and shaft 14. Lock portion 38 is coupled to the distal end of the cylindrical portion (not shown) and is of a cross section geometry substantially identical to the cross section geometry of distal end 28 of shaft 14. Other embodiments are envisioned where the cross section geometry of lock portion 38 is substantially different than then cross section geometry of distal end 28 of shaft 14. One such embodiment includes a cross-shaped lock portion 38 on a hex-shaped distal end 28 of shaft 14. Yet another alternative for lock portion 38 provides one or more cams positioned to exert tension between screwdriver 10 and screw 100. Lock portion 38 may assume most any shape such that a cross sectional perimeter of lock portion 38 is within or equal to a perimeter of distal end 28 when lock portion 38 is in one of the pre-set positions and the cross-sectional perimeter of lock portion 38 extends beyond the perimeter of distal end 28 when in a second of the pre-set positions.

Screwdriver 10 is provided to work with traditional hex (or whatever driver is chosen) screws. Additionally, screws 100 are provided to work with screwdriver 10 and to be selectively retained thereon.

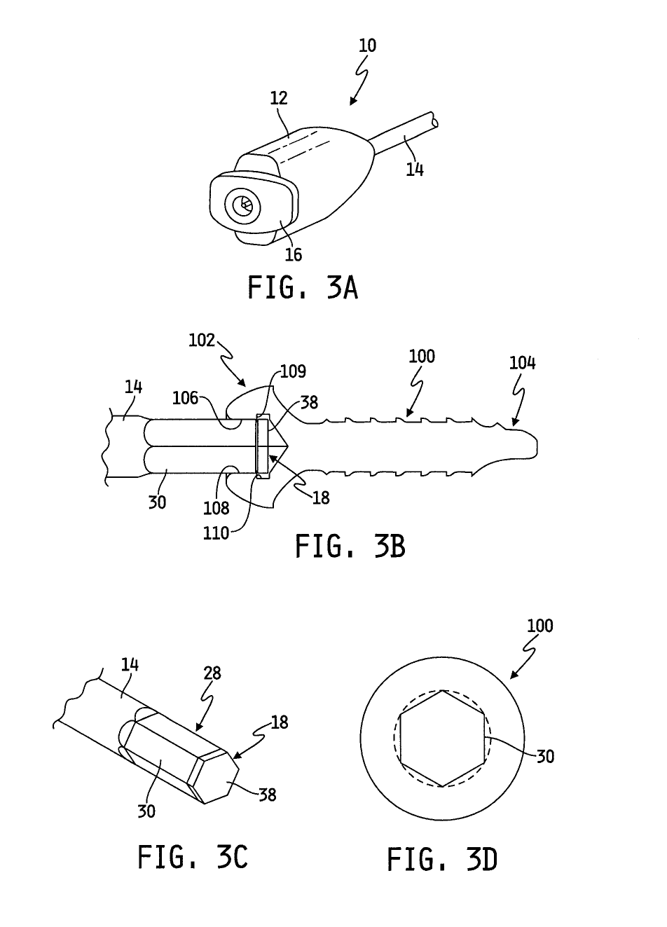

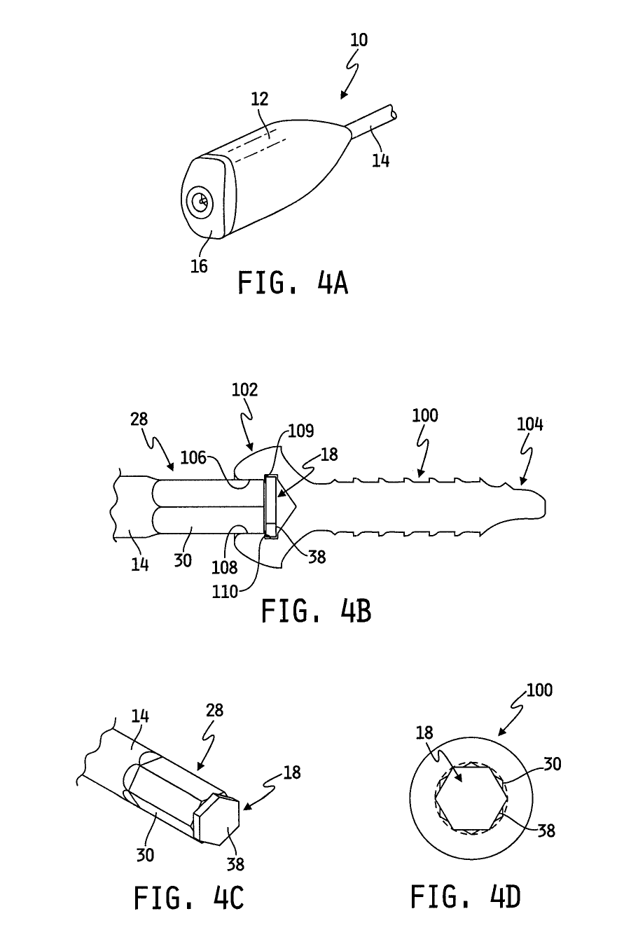

Screws 100 each include a head 102 and a threaded shaft 104. Threaded shaft 104 may be of any design of various pitches and may be made from various materials as appropriate for the selected application. As shown in FIGS. 3B and 4B, head 102 includes a socket/bore 106 having a driving section 108 and a lock section 110. Driving section 108 is shaped to engage the selected driver (hex, Phillips, square, triangle, etc.). Driving section 108 receives distal end 28 of shaft 14 and lock portion 38 of locking member 18 to allow rotation to be imparted to screw 100 from screwdriver 10. Lock section 110 is substantially circular groove and, in one embodiment, is positioned deeper within screw 100 than driving section 108. Lock section 110 is of a substantially constant diameter equal to the “opposite corner-to-corner” distance of drive section 108 so as to allow lock portion 38 to selectively rotate therein. Accordingly, a plurality of shoulders 109 are created at the interface between lock section 110 and driving section 108

In use, positive lock 16 is rotated to a first position to be misaligned with handle 12 as shown in FIG. 3A and so that lock portion 38 is aligned with distal end 28 of shaft 14, as shown in FIG. 3C. Lock portion 38 and distal end 28 of shaft 14 are then inserted into bore 106 such that lock portion 38 is positioned at a depth to align with lock section 110 as shown in FIG. 3B. Once so positioned, positive lock 16 is rotated to a second position to be aligned with handle 12 as shown in FIG. 4A. This causes lock portion 38 to be misaligned with distal end 28 of shaft 14, as shown in FIG. 4C. This misalignment results in lock portion 38 traveling rotationally within lock section 110 of screw 100 and causes lock portion 38 to engage shoulders 109 to achieve a lock position, as shown in FIGS. 4B and D. Additionally, detent 26 seats within recess 25 to frictionally hold the relative positions of lock portion 38 and drive surfaces 30. Screwdriver 10 and screw 100 are thereby directly coupled.

During a surgery, such as for securing a femoral nail application, screws 100 are placed to secure a nail in the intermedullary canal. Whereas the placement of the nail often utilizes an open procedure, performing the placement of screw 100 often involves soft tissue that must be traversed by screw 100 in order for screw 100 to arrive at the point where it will be affixed.

Screws 100 are often provided via a screw caddy (not shown). The locking of lock portion 38 and lock section 110 allows screws to be retrieved from the caddy directly by screwdriver 10.

Once screw 100 traverses the extra-osseous tissue, the engagement of driving surfaces 30 with driving section 108 of screw 100 allows rotational force to be applied to screw 100 via screwdriver 10 to effect the desired placement of screw 100. Additionally, coupling screw 100 to screwdriver 10 via lock portion 38 allows the interconnection without increase in torque being applied to screw 100. While screwdriver 10 and screw are within the anatomy of a patient, positive lock 16 provides a visual and tactile indication of the lock portion 38 orientation.

Once so placed, positive lock 16 is rotated relative to handle 12 back to the first position, shown in FIG. 3A. This rotation releases screwdriver 10 from screw 100. Screwdriver 10 is then retracted from the anatomy of the patient.

Additionally, placement of screws 100 often utilizes a cannula (not shown). The interconnection of lock portion 38 and lock section 110 allows selective fixation without increasing the diameter of the screwdriver 10 and screw 100 combination. Accordingly, the combination is compatible with typical existing cannulas. Furthermore, the combination is compatible with typically used incision sizes.

While this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

1. In combination, a bone fastener and a fastener drive tool,
the drive tool including:
a handle;
a shaft coupled to the handle and including a bit portion on a distal end thereof for engaging a socket of the bone fastener, the bit portion defining a perimeter; and
a lock rotatably coupled to the shaft for selectively coupling the bone fastener thereto, the lock having a first lock position to couple the drive tool to the bone fastener and a second lock position allowing the drive tool to be separated from the bone fastener, the lock defining a perimeter that extends beyond the perimeter of the bit portion in the first lock position; and
the bone fastener including:
a socket having at least one shoulder defined therein such that the lock engages the shoulder when the lock is in the first lock position.

2. The combination of claim 1, wherein the drive tool further includes a switch having a first switch position and a second switch position, the first switch position causing the lock to assume the first lock position and the second switch position causing the lock to assume the second lock position, the switch moving from the first switch position to the second switch position by rotation.

3. The combination of claim 2, wherein the switch provides a physical indication to a user that indicates the position of the lock.

4. The combination of claim 1, wherein the socket includes a substantially annular groove.

5. The combination of claim 2, wherein the switch is coupled to a proximal end of the handle.

6. The combination of claim 1, wherein the lock defines a perimeter that is within or equal to the perimeter of the bit portion when the lock is in the second lock position.

7. The combination of claim 1, wherein the lock is positioned distally relative to the bit portion.

8. The combination of claim 1, wherein the lock has a substantially similar cross section as a lock portion of the socket of the fastener.

9. A fastener tool including,
a handle;
a shaft coupled to the handle and including a bit portion on a distal end thereof for engaging a socket of a fastener, the bit portion defining a perimeter; and
a lock means rotatably coupled to the shaft for selectively coupling the fastener to the shaft, the lock means having a first lock position to couple the drive tool to the fastener and a second lock position allowing the drive tool to be separable from the fastener, the lock means defining a perimeter that extends beyond the perimeter of the bit portion in the first lock position.

10. The tool of claim 9, wherein the lock means includes a rod disposed within a cannula of the shaft.

11. The tool of claim 9, wherein the lock means includes a lock portion disposed on the bit portion of the shaft, the lock portion having a substantially similar cross section as the bit portion.

12. The tool of claim 9, wherein the lock means has a non-circular cross section.

13. The tool of claim 9, further including a switch having a first switch position and a second switch position, the first switch position causing the lock means to assume the first lock position and the second switch position causing the lock means to assume the second lock position and the lock means is rotationally fixed relative to the switch.

14. The tool of claim 13, wherein the switch provides a physical indication of the positioning of the lock means.

15. A method of attaching a fastener to a patient including the steps of:
providing a fastener tool having a bit portion and a lock on a distal end thereof and a switch capable of rotatably positioning the lock relative to the bit portion, the distal end of the fastener tool defining a perimeter;
placing the lock in a first position;
placing the distal end of the tool into a drive socket of the fastener;
engaging the lock by rotating the lock relative to the bit portion to expand the perimeter of the distal end of the fastener tool and to couple the fastener to the fastener tool;
affixing the fastener within the anatomy of the patient;
disengaging the lock by rotating the lock relative to the fastener tool to reduce the perimeter of the distal end of the fastener tool and to disengage the fastener from the fastener tool; and
removing the distal end of the tool from the drive socket of the fastener.

16. The method of claim 15, wherein the engaging step includes step of rotating a switch.

17. The method of claim 15, wherein the engaging and disengaging steps each include rotating the lock within the drive socket of the fastener.

18. The method of claim 15, wherein the engaging step includes causing the lock to at least one shoulder within the fastener.

19. The method of claim 15, wherein the engaging and disengaging steps each include operating a switch that provides a physical indication of the engagement status of the lock.

20. The method of claim 19, wherein the physical indication is provided at a proximal end of the fastener tool.
